(19) United States
(12) Patent Application Publication
(10) Pub. No.: US 2008/0189514 A1
(43) Pub. Date: Aug. 7, 2008

(54) Reconfigurable Logic in Processors

(76) Inventor: Raymond Mark McConnell, Bristol (GB)

Correspondence Address: WELSH & KATZ, LTD, 120 S RIVERSIDE PLAZA, 22ND FLOOR, CHICAGO, IL, 60606, US

(21) Appl. No.: 11/817,642

(22) PCT Filed: Feb. 23, 2006
(86) PCT No.: PCT/GB06/00625

§ 371 Date: Oct. 18, 2007

(30) Foreign Application Priority Data
Mar. 3, 2005 (GB) 0504454.0

(51) Int. Cl. G06F 15/76; G06F 9/30

(52) U.S. Cl. 712/28; 712/E09.016

(57) ABSTRACT

A data processor comprises an array of processing elements (PEn 4), each element in the array comprising a respective configurable logic unit (CLU 11), whereby the logic capability of each processing element can be reconfigured at will. Memory (14, FIGS. 3, 4 not shown) may be pre-loaded with configuration instructions, whereby the configuration state of each processing element can be automatically sequenced from the pre-loaded memory. The memory may be global, in which case the CLUs may be reconfigured in parallel, to perform the same function. Alternatively, the memory may be local to each processing element so that different CLUs implement different functions. Configuration may be carried out under program control at a thread switch. Each respective processing element may select, at run time, a specific configuration from a number of configurations in a microcode store. The processor is preferably a SIMD processor.

### FIELD OF THE INVENTION

The present invention relates to processors, for example data processors, in which the logic function associated with the processing elements of the processor are adapted to be reconfigured.

### BACKGROUND TO THE INVENTION

In the field of processors, there are a number of reconfigurable architectures available. These include pure reconfigurable hardware, such as FPGAs (Field Programmable Gate Arrays), reconfigurable arrays of ALUs (for example the ‘D-Fabrix’ system by Elixent) or “fab-time” reconfigurable processors (for example those produced by ARC and Tensilica). There are also combination solutions, such as FPGAs including standard CPU cores or processors including some reconfigurable logic. All of these approaches have a number of advantages and disadvantages.

Prior Art processors that attempt to provide degrees of reconfigurability can be broken down into the following types:

Processors such as those produced by ARC and Tensilica can be configured at design time, the user choosing various parameters (e.g. number of registers) and options (e.g. DSP instructions). Some of these processors are also extendible, i.e. a port (or bus) is provided to connect user-defined hardware which is accessed or controlled by special instructions. Note that these architectures are not reconfigurable. They can only be configured once when the hardware is created. They cannot then be re-targeted at another application FPGAs and higher-level reconfigurable architectures such as Elixent are reconfigurable but require hardware design techniques. Software applications have to be re-coded as hardware designs.

Existing architectures that combine processor and reconfigurable logic mostly package processor and FPGA together without fully integrating the FPGA into the processor architecture. One exception is the Stretch architecture which adds a reconfigurable datapath to a Tensilica processor to provide instruction set extensions. In this case, the reconfigurable logic is highly parallel in order to pro-vide a high level of performance when processing data. This adds to the size, power consumption and configuration complexity of the configurable logic block.

All of these technologies are basically hardware solutions that can be configured to perform different functions. This means that hardware design methods, languages and tools have to be used to define their function. Not only are these design techniques unfamiliar to software developers, they are not easy to integrate with existing software tools. The coupling of the configurable unit to the processor is usually at an API level where the program compilation and the FPGA configuration have completely independent and very different tool chains.

### SUMMARY OF THE INVENTION

The present invention adds reconfigurable logic to an existing processor in a way that extends the existing architecture in a simple and regular way. This makes the reconfigurable logic easier to access and use from standard programming languages.

The invention therefore provides a data processor comprising an array of processing elements, each element in the array comprising a respective reconfigurable logic unit, whereby the logic capability of each processing element can be reconfigured at will.

The invention provides a much closer integration of the configurable logic with a processor, in exactly the same way as existing functional units such as the Arithmetic Logic Unit (ALU). By distributing small amounts of configurable logic across an array of processing elements in a SIMD manner, the time taken for configuration (and reconfiguration) is reduced. The problem of defining the configurable logic can be addressed by providing libraries of commonly used functions. Also, because the reconfigurable logic is only used to implement a single basic function (an instruction or group of instructions) and because the data sources and destinations are already defined in the processing element architecture the task of defining that function as hardware is much less and is therefore more amenable to being done automatically by software.

The function of the Configurable Logic Unit (CLU) is either defined by a user, perhaps from a library, or automatically defined by the compilation tools, usually the inner-loop of some algorithm. Either way, new instructions are introduced to the compiler to significantly speed up frequently used operations.

The CLU's tight integration to the processor and its standardized connection to the register file makes possible automatic configuration based on analysis of the C/C++ application source code. Custom instructions can be automatically incorporated into the processor through compiler analysis of compute-intensive portions of the application software that have been flagged by the user. This automated implementation of custom instructions promises to dramatically reduce application development time compared with ASICs and FPGA-based solutions.

It is important to appreciate that the present invention is not reliant on techniques for analysing software (both source code and object code) and techniques for generating hardware (or, equivalently, data for configuring re-configurable logic), which are already known per se.

The present invention provides significant benefits, such as higher performance, the fact that a single processor architecture can be optimized/targeted for different applications, and the fact that the architecture can retain a simple programming model.

Instead of a single large block of reconfigurable logic external to the processor, our approach integrates a small amount of reconfigurable logic (the CLU) within every Processing Element in the array. The performance of the system comes from using a large number of these PEs in parallel.

Applicant's existing processors already have a highly parallel architecture. It is therefore only necessary to extend this to enable relatively simple functionality to be implemented in the configurable logic—e.g. implementing an instruction that would normally require several microcode steps in hardware. The simpler/smaller configurable logic block means that it is practical to add it to every PE. Key instructions which affect the performance of a specific application can then be implemented in hardware—without the hardware overhead of providing fixed hardware for instructions which are not used in other applications. For example, many DSP (Digital Signal Processing) applications require ‘saturating’ arithmetic where calculations that would otherwise overflow (or underflow) ‘stick’ at the maximum (or minimum) value. To add this extra functionality in hardware would be an overhead and add to the cost for non-DSP applications. To implement this in microcode would add several cycles to every arithmetic instruction, adversely affecting performance.

Instead of adding new instructions by writing microcode, the function is implemented in the configurable hardware. The same tools that currently generate microcode from a high level description of the function can be modified to generate configuration data from the same high level description.

The CLU can be configured for the system (at boot time), for the application (at run time) or dynamically (e.g. on a thread switch or under program control). Because of well-defined interfaces, control and functions the configuration should need little or no user knowledge of hardware design or FPGA tool chains.

The processor incorporating the CLU can be configured and used in many application areas. In some cases it may make economic sense to produce a more highly optimised implementation. In this case, the CLU version of the processor can be used as a development and evaluation platform to determine exactly which functions are best implemented directly in hardware. Once this is known, the CLU can be replaced by a more efficient implementation which has only the required functions implemented in fixed hardware.

### BRIEF DESCRIPTION OF THE DRAWINGS

The invention will now be described with reference to the following drawings, in which:

FIG. 1 shows a typical PE array;

FIG. 2 is a schematic block diagram of a processing element (PE) showing functional units, one of which can be a configurable logic unit (CLU);

FIG. 3 is a schematic representation of how reconfiguration can be effected by selection from RAM; and

FIG. 4 is a schematic representation of how reconfiguration can be effected by using microcode.

### DETAILED DESCRIPTION OF THE INVENTION

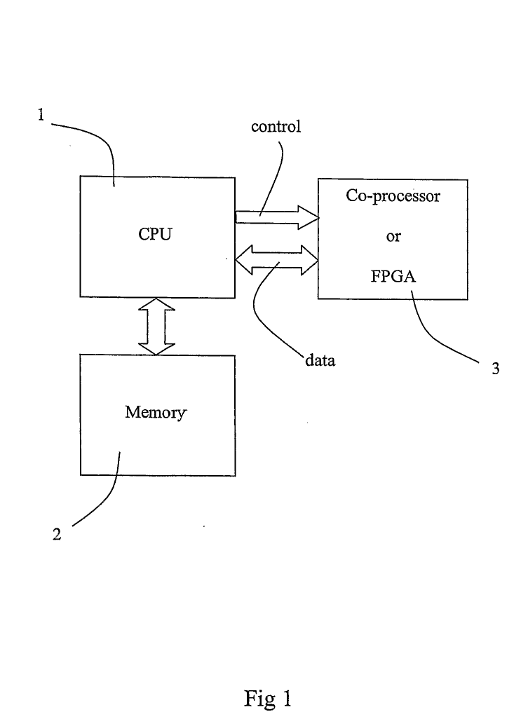

FIG. 1 depicts a generic processor 1 connected to memory 2 and to either a co-processor or FPGA 3 via a control path and a two-way data path. The co-processor or FPGA may be configurable so as to produce a configurable processor at the level discussed in the introduction above.

Application specific acceleration of many algorithms is well known to fit FPGA architectures, indeed many algorithms were designed to fit into small pieces of hardware in the first place. These algorithms have been translated into software and form small computational inner-loops, usually highly optimised. These intensive inner loops can be shown to work orders of magnitude faster when mapped back onto (configurable) hardware.

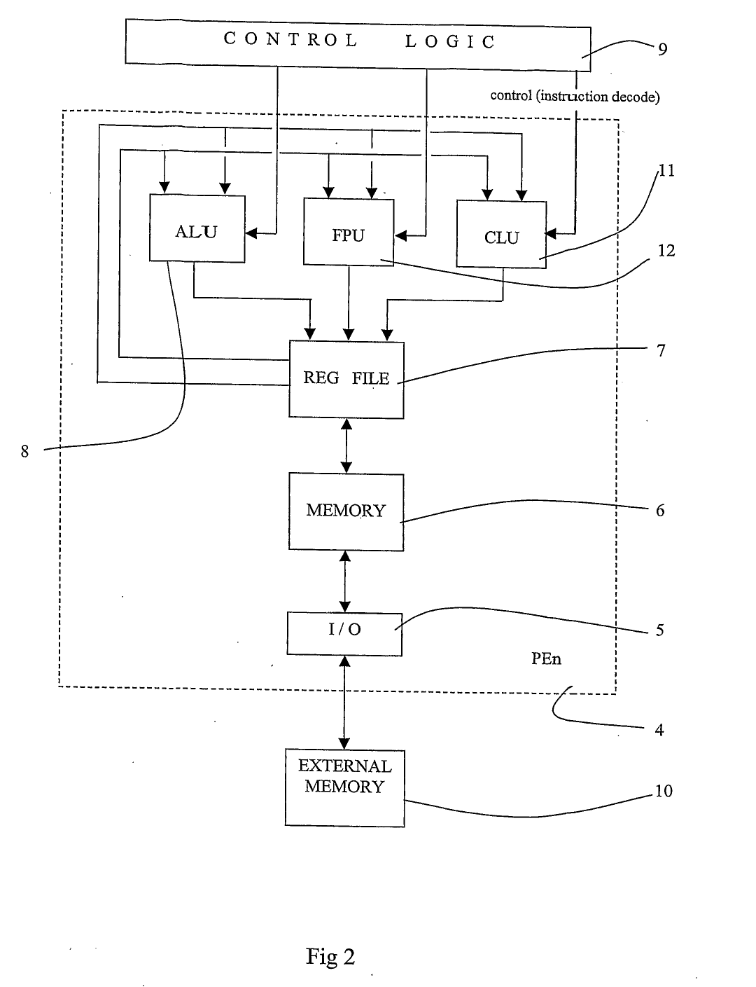

FIG. 2 illustrates schematically a processing element 4. It is one of many in an array and is hence treated as the n^{th} PE, labelled PEn, in the drawing. The array can be a SIMD array.

The PE 4 includes the usual association of I/O unit 5, local memory 6, register file 7 and arithmetic logic unit (ALU) 8. The PE 4 is under the command of a control logic unit 9. External memory 10 interfaces the PE 4 via the I/O unit 5. The ALU unit 8 is closely coupled to the register file 7. Operands from the register file 7 are connected to the ALU to perform a function as instructed by the control unit 9 and the result fed back into the register file.

The configurable logic unit 11 (CLU) is closely coupled to the PE's register file 7 in the same way as all other functional units such as the ALU 8 and a Floating Point Unit (FPU) 12. A MAC unit (not shown) may be connected in the same way as the other units. The CLU 11 is designed to be configured as a user-defined logic function, usually corresponding to a single instruction within the inner-loop of some algorithm. Once the CLU has been configured it is used in the same way as the other functional units; e.g. in the same way that the microcode instructions control the transfer of data between the register file and the ALU (or FPU), and which specific function the ALU (or FPU) performs.

The data and instruction paths are represented by the various arrows in the drawing. CLUs are connected to the register file in the standard way, i.e. inputs and outputs are of fixed width and fixed location. A number of general purpose microcode bits can be fed into all the CLUs. These can be used to both configure the CLU and to control a configured CLU.

When integrated this closely into the PE 4, the CLU configuration and programming model can be integrated with a conventional compilation tool set as it forms a method of speeding up new instructions.

This is possible because the flow of data into and out of the CLU is well defined and confined to a small number of options, hence the programming of the CLU is greatly simplified. This simplification makes it feasible for the compiler to analyse the data flow graph of a small inner loop and determine what function should be implemented in the reconfigurable hardware. This data flow graph is mapped directly onto the CLU logic as a new instruction.

This means that the programmer can be relatively unaware of the architecture (or even existence) of the accelerator and consequently performance speed-ups are more straightforward to achieve.

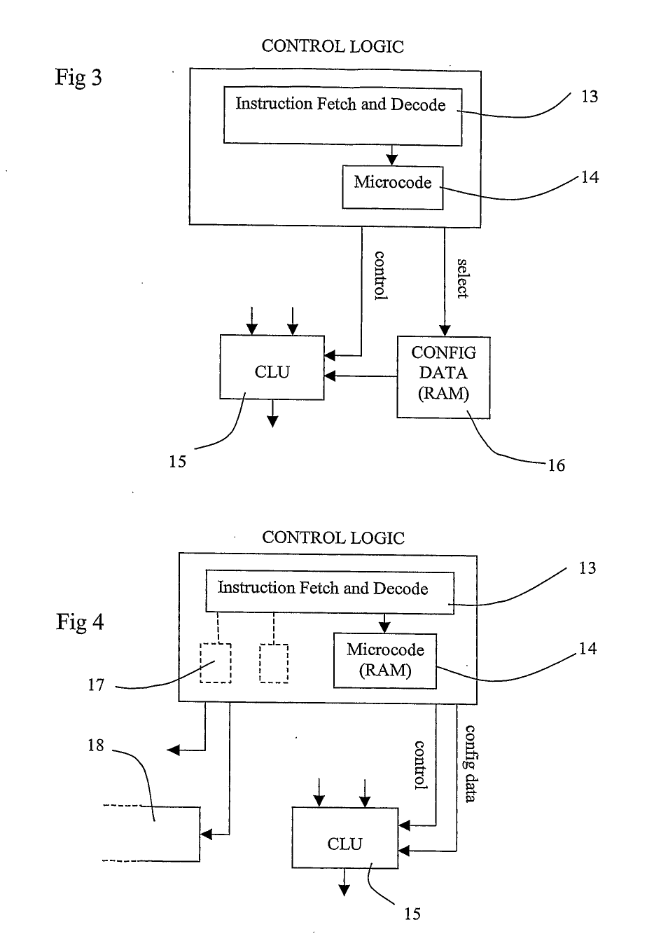

FIGS. 3 and 4 illustrate two variations in the way the CLU can be reconfigured. In FIG. 3, the control logic 9 is shown in greater detail. It includes an instruction fetch and decode unit 13 and a microcode unit 14. These units 13 and 14 control the CLU 15 and additionally provide instructions to a configuration data unit 16. This is preferably a small RAM in which is stored a set of configuration data that can be called up by using thread ID to cause the CLU 15 to reconfigure into any of a predetermined number of configurations pre-loaded in the RAM 16. One of the main advantages of this arrangement is that the instruction set from the control logic to the RAM can be much simpler and therefore faster to carry out. In this way, the CLU 15 can be loaded with a configuration selected from a “library” of predefined functions (or instructions) held in the RAM 16. This can be done explicitly by the programmer, or by the compilation tools based on analysis of the application's requirements.

FIG. 4 shows an alternative technique for reconfiguring the CLU 15. Here, the instructions for the CLU to reconfigure are derived from a microcode RAM 14 containing microcode to expand the instructions from the control logic 9. The configuration data and control instructions are fed directly to the CLU to implement reconfiguration. The Figure also shows, in ghosted lines, that other microcode RAMs 17 and CLUs 18 can be operated under the control of the same control logic 9.

Because the CLU is small and needs a small amount of configuration data, the configuration of the CLU can be done very rapidly, e.g. as a thread is switched. Since the configuration and programming model is data parallel, all CLUs in all the PEs can be configured simultaneously.

It will therefore be apparent that both configuration and control of the CLU is achieved via the normal micro-coded instructions. Configuration data can be directly held in the microcode store; in which case specially marked microcode words are used directly as configuration data. Alternatively the CLU configuration data can be held in a store specifically for that purpose; this data is loaded into the CLU when required, under control of the microcode instructions. This configuration data store can be common to all PEs or can be replicated on each PE. The latter requires more area for the store (although it reduces the area required for routing signals) but will allow faster reconfiguration.

Hence the system has two levels of microcode control: one which configures the CLU, and one which controls and provides data to the CLU on an instruction-by-instruction basis. Typically, the configuration data would be loaded into the microcode store when the processor is booted; it is then available to be loaded into the CLU as required. Since the CLU is configured from microcode instructions, there can be further overlap of program execution and configuration; i.e. in the cycles while another functional unit is being used, configuration data can be loaded into the CLU.

There can be further levels of configuration controlled either from a common configuration store, where a particular configuration is selected from a sequence of configurations, or directly by the PE itself under program control.

This allows each CLU to be configured differently, perhaps based on conditional evaluation on each PE. This means that a specific instruction op-code targeted at the CLU can perform a different function on each PE thus getting away from the strict limitations of the traditional SIMD programming model.

To summarise, all CLUs can be configured rapidly and in parallel at load time or at run-time, e.g. at a thread switch. All CLUs can be configured/modified at the same time by their PE under program control. Different PEs can have their CLUs configured differently (determined at run time) so that the same op-code implements different functions, thereby getting away from the confines of a strict SIMD model. Finally, CLUs can be configured by the PE selecting at run time a specific configuration from a number of configurations in the microcode store.

Although in the above embodiments there is an ALU as well as the CLU of the invention, there remains the possibility that the CLU could be arranged to emulate an ALU when appropriately instructed. Alternatively, the ALU could be used for performing non-saturating arithmetic and the CLU could be reserved for performing saturating arithmetic.

1. A data processor comprising an array of processing elements, each element in the array comprising a respective reconfigurable logic unit, whereby the logic capability of each processing element can be reconfigured at will.

2. A data processor as claimed in claim 1, further comprising memory means adapted to be pre-loaded with configuration instructions, whereby the configuration state of each processing element can be automatically sequenced from the pre-loaded memory means.

3. A data processor as claimed in claim 2, wherein said memory means comprises RAM.

4. A data processor as claimed in claim 3, wherein said RAM is local to each processing element.

5. A data processor as claimed in claim 4, wherein said processing elements are adapted to be reconfigured to different states such that the configurable logic units of different processing elements implement different functions.

6. A data processor as claimed in claim 3, wherein said RAM is global to all the processing elements such that all processing elements are adapted to be reconfigured to perform the same function at the same time.

7. A data processor as claimed in claim 4 or claim 6, wherein all of said configurable logic units are adapted to be configured in parallel at load time or at run-time.

8. A data processor as claimed in claim 7, wherein all of said configurable logic units are adapted to be configured at a thread switch.

9. A data processor as claimed in claim 7 or claim 8, wherein all of said configurable logic units are adapted to be configured/modified at the same time by their own respective processing element under program control.

10. A data processor as claimed in claim 4, wherein all of said configurable logic units are adapted to be configured by their own respective processing element selecting, at run time, a specific configuration from a number of configurations in a microcode store.

11. A data processor as claimed in claim 1, wherein all of said configurable logic units are adapted to be configured in response to selection at compile time from a library of predefined functions.

12. A data processor as claimed in claim 1, wherein all of said configurable logic units are adapted to be configured in response to generation at compile time by the compilation tools from an analysis of the application program.

13. A data processor as claimed in any of the preceding claims, wherein said processor is a SIMD processor.

14. A data processor as claimed in claim 1, wherein each said processing element further comprises an arithmetic logic unit.

15. A data processor as claimed in claim 14, wherein said configurable logic unit is adapted to perform saturating arithmetic and said arithmetic logic unit is adapted to perform non-saturating arithmetic.

16. A data processor as claimed in claim 1, wherein said configurable logic unit is adapted to emulate an arithmetic logic unit.

17. A data processor substantially as described herein with reference to the drawings.
